(19) United States
(12) Patent Application Publication
(10) Pub. No.: US 2006/0173125 A1
(43) Pub. Date: Aug. 3, 2006

(54) Nanoimprint lithography method and product

(76) Inventors: L. Rhys Lawson, Seattle, WA (US); Larry R. Dalton, Silverdale, WA (US); Kwan-Yue Jen, Kenmore, WA (US); Jingdong Luo, Seattle, WA (US); Sen Liu, Highland Park, NJ (US); William P. Krug, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/208,042

(22) Filed: Aug. 18, 2005

Related U.S. Application Data
(60) Provisional application No. 60/602,699, filed on Aug. 18, 2004.

(51) Int. Cl. C08L 9/00

(52) U.S. Cl. 524/571

(57) ABSTRACT

Nanoimprint lithography method and imprinted polymer film produced by the method. The polymer film includes a thermoreversibly crosslinkable polymer.

### CROSS-REFERENCE TO RELATED APPLICATION

This application claims the benefit of U.S. Patent Application No. 60/602,699, filed Aug. 18, 2004, incorporated herein by reference in its entirety.

### STATEMENT OF GOVERNMENT LICENSE RIGHTS

This invention was made with government support under Contract Number KM-5271-03, awarded by the Defense Advanced Research Projects Agency (DARPA). The government has certain rights in the invention.

### TECHNICAL FIELD

The present invention relates to a nanoimprint lithography method and products made by the method.

### BACKGROUND OF THE INVENTION

The excitement generated by organic functional materials is unavoidable and well founded, with organic light emitting diodes (OLED), transistors, photovoltaics, and electro-optic (EO) modulators comprising a few of the more prominent devices based on these molecules targeted by researchers in recent years. In many of these areas organics have begun to rival or surpass their inorganic analogs while demonstrating additional benefits such as mechanical flexibility and inexpensive fabrication. For example, EO modulators based on functional polymers and dendrimers have now surpassed the inorganic state-of-the-art, lithium niobate, by a factor of four in the key figure of merit, electro-optic coefficient (r₃₃). Similarly, organic semiconductors are competitive with amorphous silicon in electron mobility and OLEDs can now shine as brightly as traditional light sources. A similarly young field, nanoimprint lithography (NIL, also known as embossing lithography), has made much progress as an alternative to conventional photolithography that can provide the same parallel processing capabilities without the use of photoresists and the solvents associated with their processing. In the present work we address the compatibility of NIL and organic functional materials, with an emphasis on electro-optic chromophores, a class of organic functional materials that is known to be sensitive to environmental conditions (such as those in NIL), yet would benefit greatly from the attributes of this new lithographic technique.

The basic NIL experiment involves a patterned “stamp” (usually etched silicon or a similarly robust material) being pressed into a heated polymer film, and then separated after cooling, leaving the polymer film imprinted with the inverse pattern of the stamp.

Problems arise when the necessary heating stage of NIL is performed, since the temperatures for patterning a standard thermoplastic, such as polymethyl methacrylate (PMMA, T_{g} 85-100° C.), are near 200° C. (T_{g}+100° C.) since they must be able to flow into the stamp features. At these temperatures, many functional organic materials will decompose, sublime, or otherwise be rendered inactive, especially in an oxygen atmosphere. High temperatures are even more necessary if a negative stamp is used. Because this stamp type requires much more polymer area to be compressed than the “positive” version, a highly malleable matrix is needed. This is traditionally achieved through higher heating. Room and low temperature NIL have been shown, but these are almost always “positive” stampings into films that are used as an etch mask resist, and not for direct imprinting.

There are a number of solutions to the difficulty incorporating functional materials with imprint lithography. One simple approach is the use of a “softer” polymer, a material with a lower glass transition temperature that would then be able to imprint at a lower, hopefully less destructive, temperature. This is a poor solution for most applications, however, due to the decrease in overall film stability that comes with using a softer material. This will manifest itself not only in the quality of the imprinted surface, but also in the overall stability of any type of device incorporating the imprinted layer. In EO polymer devices, such as modulators, this leads to a relaxing of molecular ordering imposed by field-induced poling, thus reducing the performance and effective lifetime of the device.

A second, more elegant, solution is Step and Flash Imprint Lithography (SFIL). Through the use of a transparent stamp, a UV-curable precursor is imprinted, with no heating, due to the low viscosity of the uncured monomer. After the stamp is applied, the film is cured and the stamp is removed. This method is generally used in the same way as photolithography in that once the film is patterned it is subsequently used as an etch mask for patterning a material below the UV-curable imprinted film. Unless incorporated as a component of a UV-curable monomer, patterning a functional organic material would then require the SFIL monomer to be cast upon it, a step that introduces the same type of material compatibility issues raised with photoresists used in photolithography. Additionally, photopolymerization can be very dangerous to functional molecules due to the strength of radicals or ions generated.

This issue of material compatibility can prove difficult during processing. For example, the common EO host material amorphous polycarbonate (APC) is dissolved by almost all current positive-tone photoresists. Because of this sensitivity, heroic efforts and many different photoresists must be explored to enable photolithography for patterning device waveguides. It can be expected that similar material compatibility may arise with SFIL.

### SUMMARY OF THE INVENTION

In one aspect, the invention provides a nanoimprint lithography method. The nanoimprint lithography method provides a polymer film onto which a pattern is imprinted. In one embodiment of the method, a crosslinkable polymer film that includes a thermoreversibly crosslinkable polymer is contacted with a stamp having a pattern. In another embodiment of the method, a crosslinkable polymer film that includes a thermoreversibly crosslinkable polymer and an organic functional material is contacted with a stamp having a pattern. In the methods, the film is subjected to a temperature and pressure for a time sufficient to imprint the film with the pattern. The crosslinkable polymer and film remain crosslinkable at the temperature and pressure sufficient to imprint the pattern. The resulting imprinted polymer film is cooled to a temperature and for a time that permits the crosslinkable polymer to become crosslinked to provide an imprinted, crosslinked polymer film. Due to the relatively low temperature required to imprint the film, the method preserves the characteristics of the included functional material.

The crosslinkable polymer includes one or more diene moieties and one or more dienophile moieties. The diene and dienophile moieties are reactive to form 4+2 cycloaddition moieties. The product crosslinked polymer includes one or more 4+2 cycloaddition moieties. The 4+2 cycloaddition moieties are reactive to form diene and dienophile moieties. In one embodiment, the organic functional material is a nonlinear optical chromophore.

In another aspect of the invention, imprinted crosslinked polymer films are provided. In one embodiment, the imprinted crosslinked polymer film includes organic functional material.

In another aspect, the invention provides crosslinked polymers films. In one embodiment, the crosslinked polymer film includes organic functional material.

In other aspects, the invention provides lattices that include a thermoreversibly crosslinked polymer, and electro-optic devices that include a thermoreversibly crosslinked polymer. In certain embodiments, the crosslinked polymer includes organic functional material.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 presents cross-sectional views of a positive stamp and a negative stamp useful in the method of the invention;

FIG. 2 is a schematic illustration of a representative method of the invention using a stamp for making a Y-split waveguide, optical micrographs of the original silicon stamp and the imprinted polymer film are illustrated;

FIG. 3 is a schematic illustration of the synthesis of a representative thermally crosslinkable polymer useful in the method of the invention;

FIG. 4 illustrates differential scanning calorimetry scans of the representative polymer illustrated in FIG. 3, before and after crosslinking;

FIG. 5A is a scanning electron microscope image of a photonic crystal silicon stamp useful in the method of the invention after imprinting;

FIG. 5B is a scanning electron microscope image of a representative imprinted polymer film produced in accordance with the method of the invention at 120° C.;

FIG. 5C is a scanning electron microscope image of a detail of the imprinted film illustrated in FIG. 5B;

FIG. 5D is a scanning electron microscope image of an imprinted PMMA film produced in accordance with the method of the invention at 200° C.;

FIG. 6 illustrates the chemical structure of a representative organic functional material (a polarizable chromophore compound) useful in making the imprinted polymer films of the invention;

FIG. 7 is a graph comparing the thermal stability of a representative organic functional material (the polarizable chromophore compound illustrated in FIG. 6) at 85° C. in a representative polymer (PSDA) film and in a polymethylmethacrylate (PMMA) polymer film; and

FIG. 8 illustrates optical micrographs (200×) illustrating the temperature degradation of a polarizable chromophore during the imprinting process, chromophore degradation is observed for the amorphous polycarbonate (APC) film imprinted at 265° C. while no chromophore degradation is observed in the polymethylmethacrylate (PMMA) film imprinted at 200° C. (silicon stamp shown has 6 μm waveguides having 200 nm deep trenches, the polymer film has ribs with the same dimensions).

### DETAILED DESCRIPTION OF THE INVENTION

In one aspect, the invention provides a nanoimprint lithography (NIL) method. The nanoimprint lithography method provides a polymer film imprinted with a pattern. In the method, a crosslinkable polymer film that includes a thermoreversibly crosslinkable polymer is contacted with a stamp having a pattern. The film is then subjected to a temperature and pressure and for a time sufficient to imprint the film with the pattern. The crosslinkable polymer remains crosslinkable at the temperature and pressure sufficient to imprint the pattern. The resulting imprinted polymer film is cooled to a temperature and for a time that permits the crosslinkable polymer to become crosslinked to provide an imprinted, crosslinked polymer film.

In one embodiment of the method, a crosslinkable polymer film that includes a thermoreversibly crosslinkable polymer and an organic functional material is contacted with a stamp having a pattern. Due to the relatively low temperature required to imprint the film, the method of the invention preserves the characteristics of the included functional material.

In the method, a patterned “stamp” (usually etched silicon or a similarly robust material) is pressed into a heated polymer film. After cooling, the press and film are separated leaving the polymer film imprinted with the inverse pattern of the stamp. The method provides for the reproducible stamping of sub-100 nm features. The process is cleanroom compatible. The method of the invention is a “solvent-less” method and is attractive for working with organic functional materials, which often have sensitivity toward solvents.

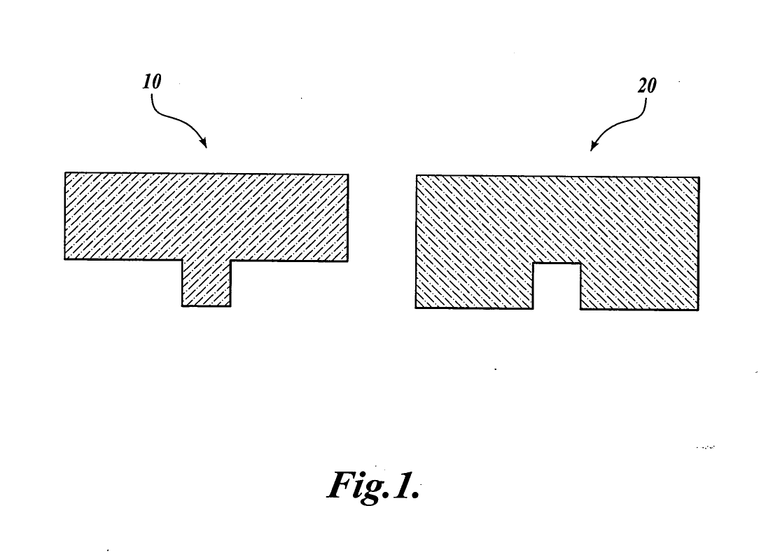

As with traditional photolithography, there are two types of lithographic modes when using the NIL method: positive and negative. Exemplary positive stamp 10 and exemplary negative stamp 20 are illustrated in FIG. 1. Negative stamps are particularly useful in fabricating optical rib waveguides patterned in a functional material.

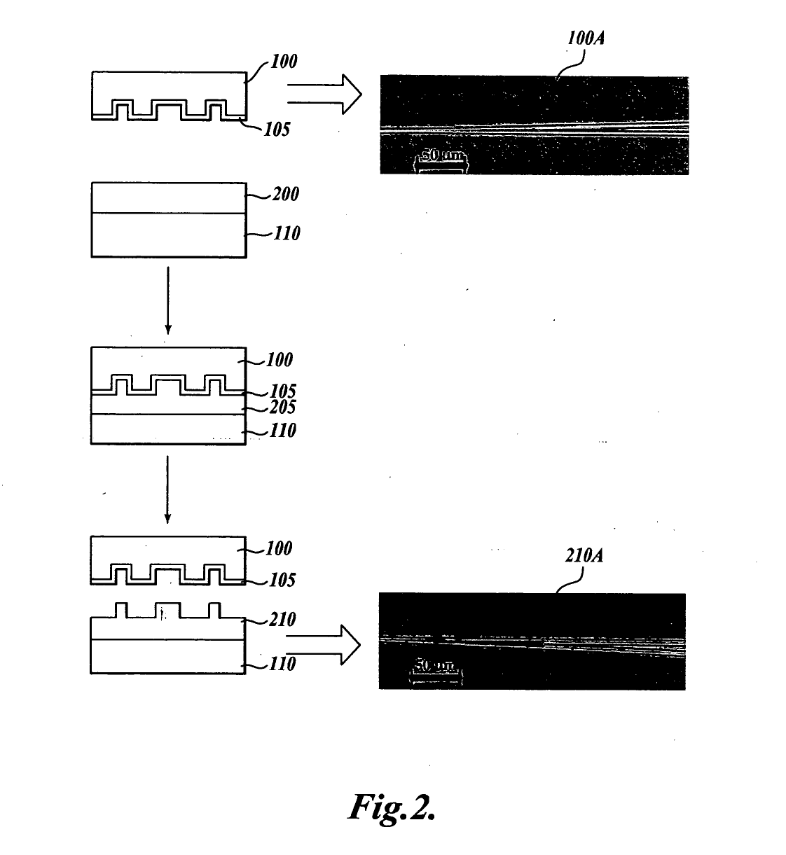

A representative imprinting method of the invention is illustrated schematically in FIG. 2. Optical micrographs of Y-split waveguides suitable for incorporation into Mach-Zehnder modulators are illustrated in FIG. 2. These waveguides are identical to those defined by photolithography, yet take hours less time to fabricate.

Referring to FIG. 2, stamp 100 having anti-adhesion layer 105 is contacted with polymer film 200 supported on substrate 110. The stamp is illustrated schematically in a cross-sectional view (100) and a plan view 100A (optical micrograph illustrating the original stamp design). The application of heat (e.g., 120-200° C.) and pressure (e.g., 100 psi) causes the polymer film to receive the imprint of stamp 100 to provide imprinted polymer film 205. Cooling and release of pressure allows the separation of stamp 100 and provides released imprinted polymer film 210. The released imprinted polymer film is illustrated schematically in a cross-sectional view (210) and a plan view 210A (optical micrograph illustrating the pattern imprinted in the polymer film).

The fabrication and properties of a representative polymer film of the invention are described in Example 1.

In the methods of the invention, the polymer film that is imprinted (i.e., receiving the stamp pattern) includes a crosslinkable polymer. The crosslinkable polymer includes one or more diene moieties and one or more dienophile moieties. The diene and dienophile moieties are reactive to form 4+2 cycloaddition moieties to effect polymer crosslinking. Crosslinking within a polymer and crosslinking between polymers can occur.

The crosslinked polymers include one or more 4+2 cycloaddition moieties formed by reaction of a diene and a dienophile. The 4+2 cycloaddition moieties are reversibly, thermally reactive to provide diene moieties and dienophile moieties.

Because of their thermoreversibility to crosslinkable polymers, the crosslinked polymers of the invention are also imprintable and useful in the method of the invention when the imprinting temperature is sufficient to revert the crosslinked polymer to a crosslinkable polymer. In this embodiment, the crosslinked polymer reverts to its corresponding crosslinkable polymer, is imprinted, and then cooled to provide the imprinted crosslinked polymer product.

The crosslinked polymers of the invention are provided by the Diels-Alder [4+2] cycloaddition reaction, which is carried out during lattice hardening. The Diels-Alder (DA) reaction involves covalent coupling of a “diene” with a “dienophile” to provide a cyclohexene cycloadduct. See, for example, Kwart, H., and K. King, Chem. Rev. 68:415, 1968. Most DA cycloadditions can be described by a symmetry-allowed concerted mechanism without generating the biradical or zwitterion intermediates. A feature of the DA reaction is that the resultant adducts can be reversibly thermally cleaved to regenerate the starting materials (i.e., diene and dienophile). For example, the retro-DA reaction has been exploited to thermally crosslink linear polymers that are capable of reverting to their thermoplastic precursors by heating. See, for example, (a) Chen, X., et al., Science 295:1698, 2002; (b) Gousse, C., et al., Macromolecules 31:314, 1998; (c) McElhanon, J. R., and D. R. Wheeler, Org. Lett. 3:2681, 2001.

The crosslinkable polymers include one or more diene moieties. As used herein, the term “diene” refers to a 1,3-diene that is reactive toward a dienophile to provide a 4+2 (Diels-Alder) cycloaddition product (i.e., a cyclohexene). Suitable diene moieties include any diene (i.e., 1,3-diene) moiety that is reactive in forming a 4+2 cycloaddition product with a dienophile. As noted above, the diene moiety is covalently coupled to the polymer backbone by the reaction of a suitable functional group on the diene moiety (e.g., carboxyl group) with a suitable functional group on the polymer (i.e., phenolic hydroxyl group). In one embodiment, the diene moiety includes a furan moiety. Representative diene moieties include furan moieties.

The crosslinkable polymers also include one or more dienophile or dienophile precursor moieties. The term “dienophile” refers to an alkene that is reactive toward a diene to provide a 4+2 cycloaddition product. The term “dienophile precursor” refers to a moiety that can be converted to a dienophile. Suitable dienophile moieties include any dienophile moiety that is reactive in forming a 4+2 cycloaddition product with a diene. Suitable dienophile precursor moieties include any dienophile precursor moiety that provides a dienophile that is reactive in forming a 4+2 cycloaddition product with a diene. In one embodiment, the dienophile moiety includes a maleimide moiety. In one embodiment, the dienophile precursor moiety includes a capped maleimide moiety (e.g., furan-capped maleimide). Representative dienophile moieties include maleimide moieties.

Suitable dienes and dienophiles (and dienophile precursors) may be unsubstituted or substituted.

The polymers useful in the method of the invention may be any one of a variety of polymers that include the diene and dienophile (or dienophile precursor) moieties. Suitable polymers include homopolymers, copolymers, block copolymers, and graft copolymers. In one embodiment, the polymer is a homopolymer to which has been grafted the diene and dienophile (or dienophile precursor) moieties. In one embodiment, the polymer is a copolymer to which has been grafted the diene and dienophile (a dienophile precursor) moieties. In one embodiment, the polymer has a functional group that is suitable for reaction with suitably functionalized diene and dienophile (or dienophile precursor) compound to covalently couple the diene and dienophile (or dienophile precursor) moieties to the polymer backbone.

The polymers may be prepared through grafting, for example, by covalently coupling a diene moiety and a dienophile (or dienophile precursor) moiety to a polymer backbone, where a suitable functional group (e.g., carboxyl group) on the diene moiety and dienophile (or dienophile precursor) moiety reacts with a suitable functional group on the polymer (e.g., phenolic hydroxyl group). Alternatively, the polymer may be prepared by reacting a diene (or diene precursor) containing a polymerizable group, and a dienophile (or dienophile precursor) containing a polymerizable group to form a polymer. Combinations of polymerizing and grafting may also be used. Representative polymers useful in making the crosslinkable polymers of the invention include poly(vinylphenol) polymers, polyvinyl polymers, and amorphous polycarbonate polymers.

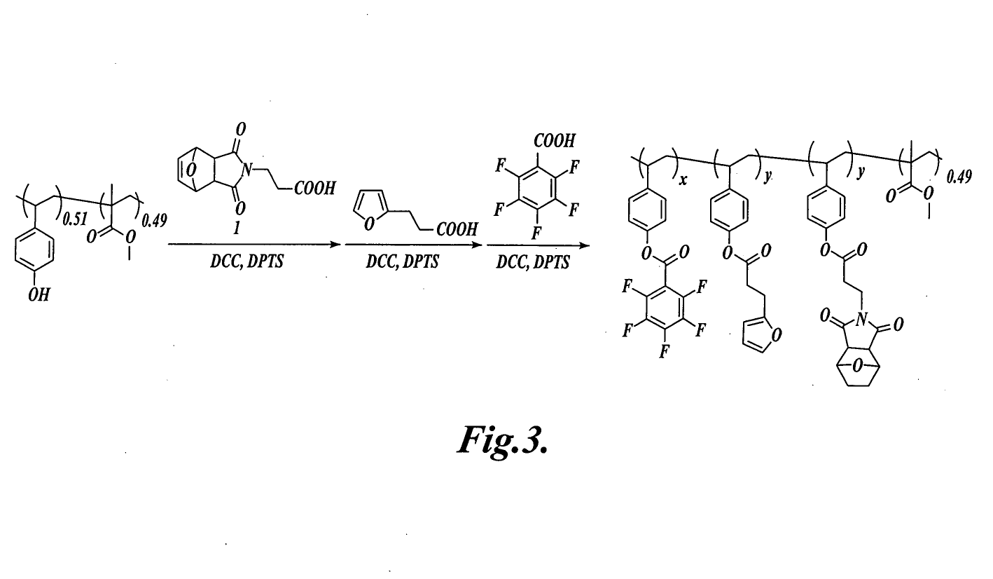

The synthesis of a representative crosslinkable polymer useful in the method of the invention is described in Example 2 and is illustrated schematically in FIG. 3. FIG. 3 illustrates the preparation of a poly(4-vinylphenol)-based polymer (PSDA) that includes a dienophile precursor (i.e., masked maleimide) moiety and a diene (i.e., furan) moiety.

The crosslinkable polymer illustrated in FIG. 3 is a graft copolymer having a polymer backbone to which are grafted pendant groups. The polymer backbone includes 4-vinylphenol and methyl methacrylate repeating units. The backbone copolymer is prepared by the copolymerization of 4-vinylphenol and methyl methacrylate. As illustrated in FIG. 3, the copolymer includes about equal numbers of each repeating unit: 0.51 mole percent 4-vinylphenol and 0.49 mole percent-methyl methacrylate. It will be appreciated that the 4-vinylphenol and methyl methacrylate repeating units do not necessarily occur in blocks as depicted schematically in FIG. 3.

The crosslinkable polymer's pendant groups are grafted to the polymer backbone by covalent coupling. As illustrated in FIG. 3, the dienophile precursor (protected maleimide) is covalently coupled to the polymer backbone through esterification of the polymer's phenolic group by the modified maleimide's carboxylic acid group; the diene (furan) is similarly covalently coupled to the polymer backbone through esterification of the polymer's phenolic group by the modified furan's carboxylic acid group; and pentafluorobenzoic acid is covalently coupled to the polymer backbone through esterification of the polymer's phenolic group by the benzoic acid's carboxylic acid group. The benzoic acid is included to control the amount of diene and dienophile (or dienophile precursor) incorporated into the polymer. It will be appreciated that other groups are suitable. Pentafluorobenzate is non-reactive and has favorable communication properties at telecommunication wavelengths.

Through the selection of the imprintable crosslinkable polymer, the imprinting process parameters (e.g., temperature and pressure) can be tuned. The polymer's glass transition temperature determines, in part, the imprinting process parameters.

Polymers useful in the invention have glass transition temperatures suitable for imprinting by the method of the invention. Suitable polymers can be derived from one or more monomers to provide polymers having the desired glass transition temperature (i.e., rigidity) and optical properties. The polymer's glass transition can be tuned by selection of the types and percentages of the monomers making up the polymer backbone. In one embodiment, the polymer has a glass transition temperature from about 85° C. to about 300° C. In another embodiment, the polymer has a glass transition temperature from about 100° C. to about 200° C. In another embodiment, the polymer has a glass transition temperature from about 120° C. to about 150° C.

Representative monomers useful in making polymers imprinted by the method of the invention include methyl methacrylate. Methyl methacrylate incorporated into a polymer backbone imparts rigidity to the polymer by increasing the polymer's glass transition temperature. Poly(methyl methacrylate) polymers are also optically transparent at telecommunications wavelengths. Poly(vinyl) polymers and amorphous polycarbonate polymers also have glass transition temperatures and optical properties making them useful in the method of the invention to provide materials suitable for telecommunications applications.

As illustrated in FIG. 3, the representative crosslinkable polymer includes x mole percent pendant pentafluorophenyl groups, y mole percent furan groups, and y mole percent capped maleimide groups, with x=0.306 and y=0.102. It will be appreciated that the phenyl, furan, and capped maleimide groups do not necessarily occur in blocks as depicted schematically in FIG. 3. It will also be appreciate that the ratio of x:y can vary depending on the desired extent of crosslinking.

Although a representative polymer is described as having the specific components noted above, it will be appreciated that the polymers of the invention can include a variety of dienophiles and dienes.

To provide a 1:1 relationship between diene and dienophile for the 4+2 cycloaddition crosslinking process, the percentage of diene and dienophile moieties in the polymer are about equal (1:1). The mole percentage of diene and dienophile moieties in the crosslinkable polymer can vary to provide crosslinked polymers having the desired imprintable properties and crosslinking. Representative polymers of the invention have a mole percent diene of from about 0.01 to about 0.25. In one embodiment, the mole percent diene is from about 0.02 to about 0.15. In one embodiment, the mole percent diene is from about 0.05 to about 0.10. Because of the approximate 1:1 relationship between diene and dienophile, the mole percent dienophile is the same as noted above for the diene.

In the synthesis of the polymer, the maleimide (dienophile) is protected with furan to prevent any crosslinking reaction from occurring prior to the lattice hardening step. The resultant polymer possesses good solubility in common organic solvents, such as chloroform and THF. The polymer was characterized by ¹H NMR, ¹⁹F NMR, UV-Vis spectroscopy, GPC, and thermal analysis, as described in the Example 2.

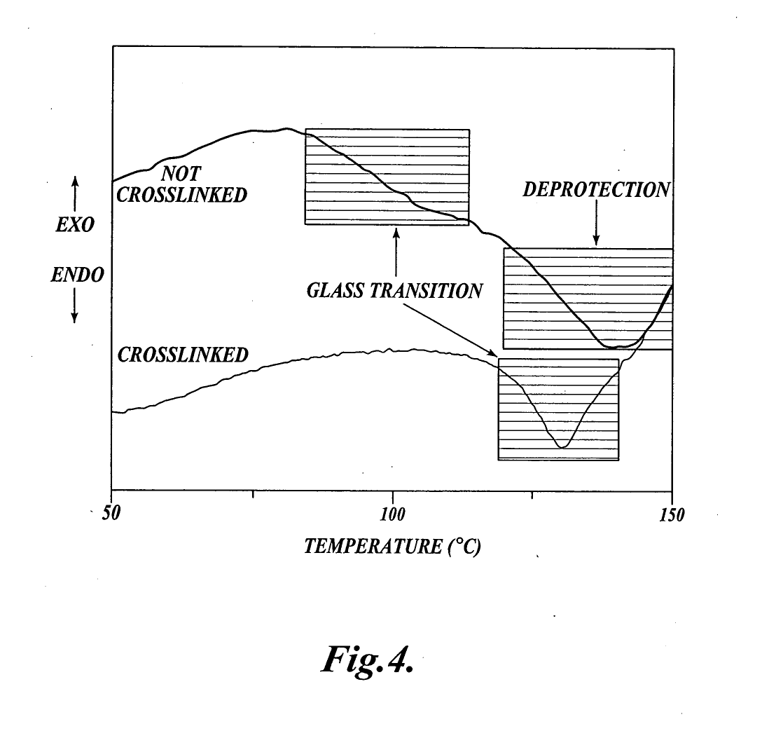

The furan used for protecting the maleimide moiety is thermally cleaved by retro-DA reaction and easily evaporated from the polymer to provide the maleimide moiety as dienophile. The loss of furan and the formation of the maleimide moiety as dienophile can be clearly verified by thermal analysis. FIG. 4 is a graph illustrating the thermal analysis of a representative polymer (PSDA) before and after crosslinking. Thermal analysis by differential scanning calorimetry (DSC) shows an endothermic peak observed in the temperature range from 110° C. to 150° C., which corresponds to maleimide deprotection. Differential scanning calorimetry demonstrates the difference between the initial, furan protected, non-crosslinked polymer and the deprotected, hardened material. A shift in glass transition temperature of +50° C. is shown.

The crosslinkable polymer (PSDA) alone was imprinted and the resulting films evaluated. The polymer was spin-coated onto cleaned silicon chips (i.e., Si<100>, 1 cm²) to provide films having thickness from 1 to 2 microns. The films were then solidified (without crosslinking) in a vacuum oven for four hours at 70° C. Imprinting was done using a Tetrahedron MTP-13 hot press (Tetrahedron and Associates, Inc., San Diego, Calif.). First, the polymer-coated chip was placed in the open press and the platens were heated to a maximum of 120° C. for 20 minutes. This heating resulted in “deprotection” of the polymer and evaporation of the protecting furan group. The etched silicon stamp was then placed on top of the polymer and the press was closed to 100 psi. The press was then cooled to 90° C. for up to one hour as crosslinking proceeded. Finally, the press was cooled to room temperature and the pressure released. The stamp and polymer separated as the press opened, leaving the polymer imprinted and the stamp indefinitely reusable. Depending on the nature of the organic functional molecule (guest/host or copolymer), the imprinting temperatures and times will change slightly, as will the stability of the overall finished film (e.g., a guest/host system will have a slightly lower T_{g} than the pure PSDA film). A polymer having a thermal glass transition temperature near room temperature can be imprinted with no heating and a pressure of about 100 psi, or mild heating with less pressure (e.g., 10 psi). Conversely, a polymer having a relatively high thermal glass transition temperature will require increased temperature for similar pressures (compared to above), or increased temperature and increased pressure. For example, while polymethyl methacrylate (PMMA) can be imprinted at 200° C. and 100 psi, imprinting amorphous polycarbonate is carried out at 280° C. and 100 psi.

The method of the invention provides imprinted films using temperatures in the range from about room temperature to about 200° C. and pressures from about 25 psi to about 300 psi.

Using the passive polymer, PSDA, imprinting was performed with a maximum temperature of 120° C. using an ebeam written photonic crystal. Silicon stamps based on a photonic crystal design were fabricated using ebeam lithography. These photonic crystal designs are not intended as actual functional devices, but are used to demonstrate their nanoscale features and diverse surface patterns in the method of the invention. Stamps were coated with the fluorinated anti-adhesion layer 1H,1H,2H,2H-perfluorodecyltrichlorosilane (FDTS).

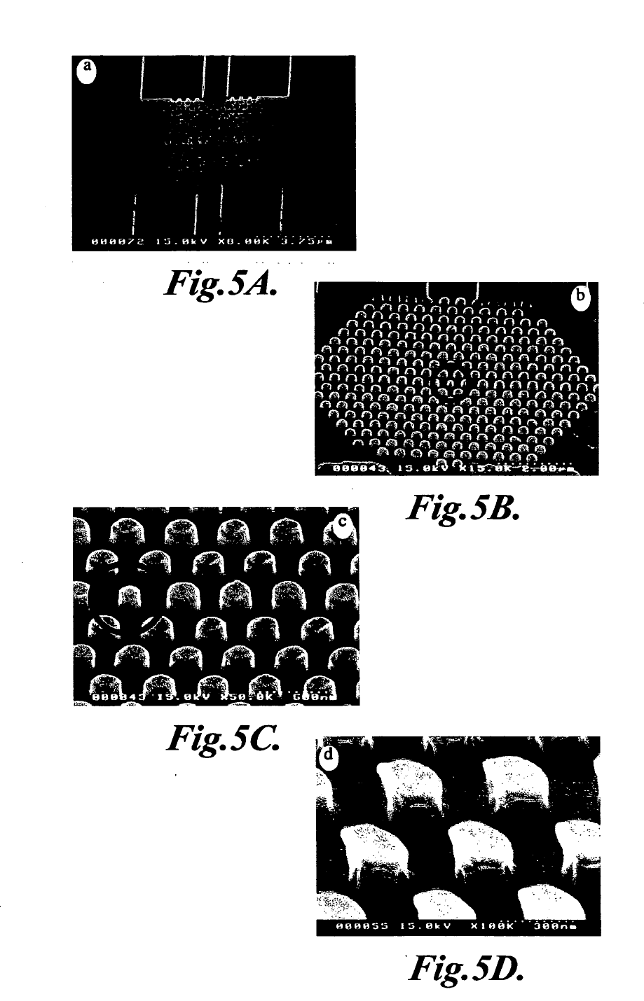

The results of the imprinting process are illustrated in the scanning electron microscope (SEM) images shown in FIG. 5: FIG. 5A is an image of the photonic crystal silicon stamp (after imprinting); FIG. 5B is an image of the imprinted polymer (PSDA) film; FIG. 5C is a detail of the imprinted polymer (PSDA) film; and FIG. 5D is an image of the imprinted polymer (PMMA) film, imprinted by the same method described above except using polymethylmethacrylate (PMMA) as the polymer and heating at 200° C. The circled feature in FIGS. 5A-5C is the 100 nm wide, 200 nm tall “central defect” of the photonic crystal.

Profilometer analysis confirmed the close match between stamp and imprinted film features in both height and area. FIG. 5 demonstrates that the photonic crystal design is reproduced with very high fidelity. The “central defect” of the photonic crystal design, a 100 nm wide, 200 nm tall post, demonstrates the nanoscale range of this method.

While the fidelity of pattern transfer is impressive, the most exciting aspect is the low temperature at which this direct imprinting is achieved. Through the use of a crosslinkable polymer (e.g., PSDA), the temperature needed to imprint was reduced almost 100° C. when compared to imprinting of PMMA. An identically stamped PMMA film is shown in FIG. 5D for comparison to the PSDA results. While the stamping fidelity in PMMA is acceptable, close inspection reveals distortions in the shape of the posts. The defect is likely due to the mechanical separation of stamp and imprinted film. Even though PMMA is considered a fairly rigid matrix, PMMA is soft compared to the crosslinked PSDA, which was stamped at a much lower temperature with no distortion.

As noted above, the crosslinkable polymer film and the crosslinked polymer film include an organic functional material. As used herein, the term “organic functional material” refers to an organic compound or material having a useful functional property. Functional properties include semiconduction, light emission, actuation, electro-optic modulation, all-optical switching and modulation, optical rectification, terahertz generation, and photovoltaic properties. Representative organic functional materials include nonlinear optical chromophores (e.g., polarizable chromophores), organic semiconductors (e.g., pentacene, polythiophenes), and light emitters (e.g., Alq3, polymer emitters, dye-doped light emitters, organometallic light emitters).

Organic functional materials include nonlinear optical chromophore compounds (polarizable chromophores). As used herein, the term “chromophore” refers to a compound that can absorb a photon of light. The term “nonlinear” refers second order effects that arise from the nature of the polarizable chromophore (i.e., “push-pull” chromophore) having the general structure D-π-A, where D is an electron donor, A is an electron acceptor, and π is a π-bridge that conjugates the donor to the acceptor.

A “donor” (represented by “D”) is an atom or group of atoms with low electron affinity relative to an acceptor (defined below) such that, when the donor is conjugated to an acceptor through a π-bridge, electron density is transferred from the donor to the acceptor.

An “acceptor” (represented by “A”) is an atom or group of atoms with high electron affinity relative to a donor such that, when the acceptor is conjugated to a donor through a π-bridge, electron density is transferred from the acceptor to the donor.

A “π-bridge” or “conjugated bridge” (represented in chemical structures by “π” or “πⁿ” where n is an integer) is comprised of an atom or group of atoms through which electrons can be delocalized from a donor to an acceptor through the orbitals of atoms in the bridge. Preferably, the orbitals will be p-orbitals on multiply bonded carbon atoms such as those found in alkenes, alkynes, neutral or charged aromatic rings, and neutral or charged heteroaromatic ring systems. Additionally, the orbitals can be p-orbitals on multiply bonded atoms such as boron or nitrogen or organometallic orbitals. The atoms of the bridge that contain the orbitals through which the electrons are delocalized are referred to here as the “critical atoms.” The number of critical atoms in a bridge can be a number from 1 to about 30. The critical atoms can also be substituted with, for example, alkyl, aryl, or other groups. One or more atoms, with the exception of hydrogen, on alkyl or aryl substituents of critical atoms in the bridge may be bonded to atoms in other alkyl or aryl substituents to form one or more rings.

Representative chromophores, donors, acceptors, and π-bridges useful in making the polymer films of the invention include those described in U.S. Pat. Nos. 6,361,717; 6,348,992; 6,090,332; 6,067,186; 5,708,178; and 5,290,630; each expressly incorporated herein by reference in its entirety. Representative chromophores useful in making the polymer films of the invention are described in WO 02/08215; U.S. patent application Ser. No. 10/212,473, filed Aug. 2, 2002; U.S. patent application Ser. No. 10/347,117, filed Jan. 15, 2003; and U.S. Provisional Patent Application No. 60/520,802, filed Nov. 17, 2003; Adv. Mater. 14(23):1763-1768, 2002; and Adv. Mater. 14(19):1339-1365, 2002; each expressly incorporated herein by reference in its entirety.

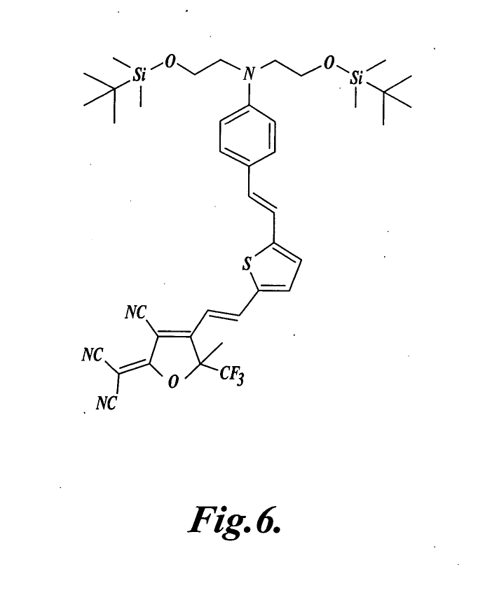

Representative organic functional materials include nonlinear optical chromophore compounds such as the chromophore illustrated in FIG. 6.

In another aspect, the invention provides an imprinted polymer film. In one embodiment, the imprinted polymer film includes an organic functional material. The fabrication of a representative imprinted polymer film including an organic functional material is described in Example 1. The film includes the compound illustrated in FIG. 6, a representative polarizable chromophore (20 percent by weight based on the weight of the polymer, PSDA).

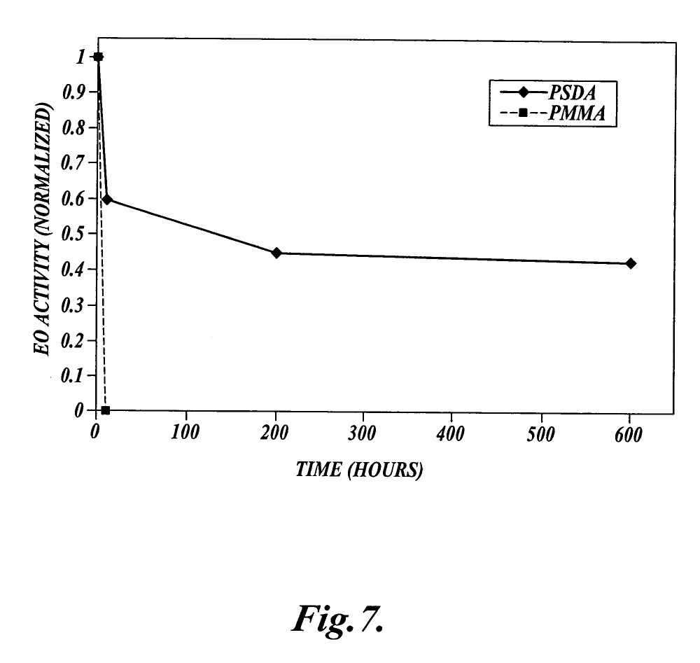

The method for making the polymer film includes applying the crosslinkable polymer and the organic functional material to a substrate. A solution of the chromophore and crosslinkable polymer was spin cast onto ITO/glass substrates. The substrates were then divided into two groups: those to be imprinted and those not to be imprinted. The samples to be imprinted were subjected to the imprinting method described above. The other samples were simply cured using the same temperature profile, but in an oven instead of a press. Due to the nature of the characterization experiment for electro-optic materials, a flat polymer surface is needed, and so a featureless silicon stamp was used. After imprinting, gold electrodes were evaporated onto all samples for poling and electro-optic testing using the simple reflection method. C. C. Teng, H. T. Man, Appl. Phys. Lett. 1990, 56, 1734. There was no discernable difference in the electrostatic poling behavior of the stamped samples versus the non-stamped samples. Similarly, the electro optic coefficient (r₃₃) also showed no difference between the two sample types. The average electro-optic (EO) coefficient of both sample types was 90 pm/V. The long-term stability of the low temperature crosslinkable sample is quite good in comparison to a guest host system (ALJ8 in PMMA). This stability was demonstrated by periodically monitoring (by simple reflection) the electo-optic activity of the electro-optic chromophore doped into PMMA and PSDA as the samples were baked in an 85° C. vacuum oven. The results are shown in FIG. 7 and demonstrate the stability of PSDA as a host compared to PMMA. In fact, the stability of these PSDA devices rivals previously published reports of amorphous polycarbonate (APC) stability, considered the current state of the art for thermal stability within the field. C. Zhang, L. R. Dalton, M.-C. Oh, H. Zhang, W. H. Steier, Chem. Mater. 2001, 13, 3043.

For the polymer systems described herein, an ideal stamping temperature lies near T_{g}+100° C., where T_{g} is the glass transition temperature of the polymer system. A commonly used polymer in NIL is PMMA, which has a T_{g} of 85-100° C., meaning it would be imprinted at 185-200° C. for the best results. A pressure of 100 psi produces consistently reproducible results across polymer systems.

For electro-optic (EO) polymers, heating to high temperatures can cause problems due to degradation of the included electro-optic chromophores. Temperatures above 250° C. can cause decomposition of some compounds, rendering the resulting imprinted film non-functional. Such decomposition is a major concern for NIL methods because a high T_{g} matrix is very desirable for device stability, meaning that attempts to improve the thermal stability of electro-optic devices through using a rigid matrix may result in damage to the chromophore when using NIL on these polymers. Amorphous polycarbonate (APC) is the current standard for electro-optic host materials, partially because of its high glass transition (165° C. when loaded with chromophore).

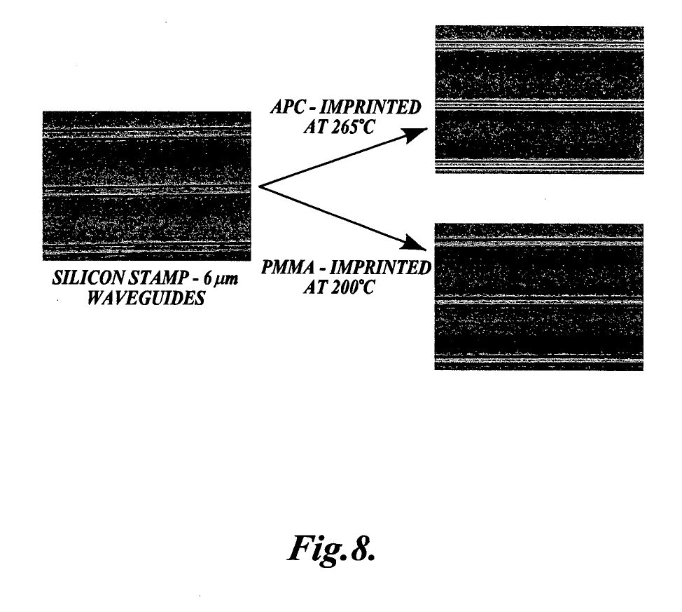

Imprinted electro-optic chromophore-loaded polymer films (APC and PMMA), prepared as described in Example 1, are shown in FIG. 8. In these films, the electro-optic chromophore was CLD. Imprinting at 265° C. results in the degradation of the chromophore in the APC film (film's color change observed). Imprinting the PMMA film at 200° C. leaves the chromophore intact and retaining its characteristics. Although imprinting the CLD/APC polymer film at 265° C. transfers the pattern perfectly, the chromophore is destroyed.

The method of the invention provides a solution to the problem of temperature-sensitive functional materials through the use of “smart-crosslinking” polymers that are “soft” when spin cast, but “hardened” through crosslinking when heated to a mild temperature. Integrating these polymers into the imprint lithography method means that a soft film can be hardened (crosslinked) during imprinting. The resulting film is comparable to APC in thermal stability yet can be imprinted at 100° C., leaving any thermally-sensitive functional material unharmed by heating.

The method of the invention has been used to fabricate both passive and active optical circuitry.

The method provides imprinted, crosslinked polymer films that include organic functional materials. The crosslinked polymers films have a variety of uses including in electro-optic devices.

The imprinted film produced by the method can have electro-optic activity that results directly from the imprinting method. In this embodiment, poling of the film containing a nonlinear optically active chromophore during imprinting (electric field applied during imprinting) can align the chromophores in the softened film, which is then cooled and crosslinked to provide a film having electro-optic activity.

In another aspect, the invention provides a method for making a film having electro-optic activity from an imprinted film formed as described herein.

In one embodiment, the method includes the steps of heating a film including a polarizable chromophore and a crosslinkable polymer to form a softened polymer film; subjecting the softened polymer film to an electric field to provide a polymer film including aligned, polarizable chromophore compounds; and cooling the poled polymer film to a temperature sufficient to provide a hardened, crosslinked polymer including aligned, polarizable chromophores.

In this embodiment of the method, the combination of polarizable chromophore and crosslinkable polymer having one or more diene moieties and one or more dienophile moieties is poled in an electric field to provide a crosslinkable polymer and aligned, polarizable chromophores. The crosslinkable polymer is then crosslinked to provide a crosslinked polymer film and immobilized aligned, polarizable chromophores. The polymer crosslinks include 4+2 cycloaddition moieties formed by reaction of diene and dienophile moieties.

In one embodiment, the method further includes the steps of heating the hardened, crosslinked polymer and immobilized aligned, polarizable chromophore compounds at a temperature sufficient to provide a softened, crosslinkable polymer; subjecting the softened, crosslinkable polymer to an electric field to further pole the chromophore compounds; and then cooling the poled crosslinkable polymer to a temperature sufficient to provide a hardened, crosslinked polymer having immobilized aligned, polarizable chromophore compounds. In this embodiment, the initially formed crosslinked polymer is heated at a temperature sufficient to cause one or more of the 4+2 cycloaddition moieties to react (retro-DA) to form one or more diene moieties and one or more dienophile moieties to provide a crosslinkable polymer. The crosslinkable polymer is then poled to provide a poled polymer film having an increased number of aligned chromophore compounds. The poled polymer film having an increased number of aligned chromophore compounds is then crosslinked to provide a second crosslinked, poled polymer film having increased aligned chromophore compounds compared to the initially formed crosslinked polymer film. These steps may be repeated to further enhance chromophore alignment.

In other aspects, the invention provides lattices that include a thermoreversibly crosslinked polymer and organic functional material, and electro-optic devices that include a thermoreversibly crosslinked polymer and organic functional material.

The materials and methods described herein can be useful in a variety of electro-optic applications. In addition, these materials and methods may be applied to polymer transistors or other active or passive electronic devices, as well as OLED (organic light emitting diode) or LCD (liquid crystal display) applications.

The use of organic polymers in integrated optics and optical communication systems containing optical fibers and routers has been previously described. The compounds, molecular components, polymers, and compositions (hereinafter, “materials”) may be used in place of currently used materials, such as lithium niobate, in most type of integrated optics devices, optical computing applications, and optical communication systems. For instance, the materials may be fabricated into switches, modulators, waveguides, or other electro-optical devices.

For example, in optical communication systems devices fabricated from the materials described herein may be incorporated into routers for optical communication systems or waveguides for optical communication systems or for optical switching or computing applications. Because the materials are generally less demanding than currently used materials, devices made from such polymers may be more highly integrated, as described in U.S. Pat. No. 6,049,641, which is incorporated herein by reference. Additionally, such materials may be used in periodically poled applications as well as certain displays, as described in U.S. Pat. No. 5,911,018, which is incorporated herein by reference.

Techniques to prepare components of optical communication systems from optically transmissive materials have been previously described, and may be utilized to prepare such components from materials provided by the present invention. Many articles and patents describe suitable techniques, and reference other articles and patents that describe suitable techniques, where the following articles and patents are exemplary:

Eldada, L. and L. Shacklette, “Advances in Polymer Integrated Optics,” IEEE Journal of Selected Topics in Quantum Electronics 6(1):54-68, January/February 2000; Wooten, E. L., et al. “A Review of Lithium Niobate Modulators for Fiber-Optic Communication Systems,” IEEE Journal of Selected Topics in Quantum Electronics 6 (1):69-82, January/February 2000; Heismann, F., et al. “Lithium Niobate Integrated Optics: Selected Contemporary Devices and System Applications,” Optical Fiber Telecommunications III B, Academic, Kaminow and Koch (eds.), New York, 1997, pp. 377-462; Murphy, E., “Photonic Switching,” Optical Fiber Telecommunications III B, Academic, Kaminow and Koch (eds.), New York, 1997, pp. 463-501; E. Murphy, Integrated Optical Circuits and Components: Design and Applications., Marcel Dekker, New York, August 1999; Dalton, L., et al., “Polymeric Electro-Optic Modulators: From Chromophore Design to Integration with Semiconductor Very Large Scale Integration Electronics and Silica Fiber Optics,” Ind. Eng. Chem. Res. 38:8-33, 1999; Dalton, L., et al., “From Molecules to Opto-Chips: Organic Electro-Optic Materials,” J. Mater. Chem. 9:1905-1920, 1999; Liakatas, I. et al., “Importance of Intermolecular Interactions in the Nonlinear Optical Properties of Poled Polymers,” Applied Physics Letters 76(11): 1368-1370, Mar. 13, 2000; Cai. C., et al., “Donor-Acceptor-Substituted Phenylethenyl Bithiophenes: Highly Efficient and Stable Nonlinear Optical Chromophores,” Organic Letters 1(11):1847-1849, 1999; Razna, J., et al., “NLO Properties of Polymeric Langmuir-Blodgett Films of Sulfonamide-Substituted Azobenzenes,” J. of Materials Chemistry 9:1693-1698, 1999; Van den Broeck, K., et al., “Synthesis and Nonlinear Optical Properties of High Glass Transition Polyimides,” Macromol. Chem. Phys 200:2629-2635, 1999; Jiang, H., and A. K. Kakkar, “Functionalized Siloxane-Linked Polymers for Second-Order Nonlinear Optics,” Macromolecules 31:2508, 1998; Jen, A. K.-Y., “High-Performance Polyquinolines with Pendent High-Temperature Chromophores for Second-Order Nonlinear Optics,” Chem. Mater. 10:471-473, 1998; “Nonlinear Optics of Organic Molecules and Polymers,” Hari Singh Nalwa and Seizo Miyata (eds.), CRC Press, 1997; Cheng Zhang, Ph.D. Dissertation, University of Southern California, 1999; Galina Todorova, Ph.D. Dissertation, University of Southern California, 2000; U.S. Pat. Nos. 5,272,218; 5,276,745; 5,286,872; 5,288,816; 5,290,485; 5,290,630; 5,290,824; 5,291,574; 5,298,588; 5,310,918; 5,312,565; 5,322,986; 5,326,661; 5,334,333; 5,338,481; 5,352,566; 5,354,511; 5,359,072; 5,360,582; 5,371,173; 5,371,817; 5,374,734; 5,381,507; 5,383,050; 5,384,378; 5,384,883; 5,387,629; 5,395,556; 5,397,508; 5,397,642; 5,399,664; 5,403,936; 5,405,926; 5,406,406; 5,408,009; 5,410,630; 5,414,791; 5,418,871; 5,420,172; 5,443,895; 5,434,699; 5,442,089; 5,443,758; 5,445,854; 5,447,662; 5,460,907; 5,465,310; 5,466,397; 5,467,421; 5,483,005; 5,484,550; 5,484,821; 5,500,156; 5,501,821; 5,507,974; 5,514,799; 5,514,807; 5,517,350; 5,520,968; 5,521,277; 5,526,450; 5,532,320; 5,534,201; 5,534,613; 5,535,048; 5,536,866; 5,547,705; 5,547,763; 5,557,699; 5,561,733; 5,578,251; 5,588,083; 5,594,075; 5,604,038; 5,604,292; 5,605,726; 5,612,387; 5,622,654; 5,633,337; 5,637,717; 5,649,045; 5,663,308; 5,670,090; 5,670,091; 5,670,603; 5,676,884; 5,679,763; 5,688,906; 5,693,744; 5,707,544; 5,714,304; 5,718,845; 5,726,317; 5,729,641; 5,736,592; 5,738,806; 5,741,442; 5,745,613; 5,746,949; 5,759,447; 5,764,820; 5,770,121; 5,76,374; 5,776,375; 5,777,089; 5,783,306; 5,783,649; 5,800,733; 5,804,101; 5,807,974; 5,811,507; 5,830,988; 5,831,259; 5,834,100; 5,834,575; 5,837,783; 5,844,052; 5,847,032; 5,851,424; 5,851,427; 5,856,384; 5,861,976; 5,862,276; 5,872,882; 5,881,083; 5,882,785; 5,883,259; 5,889,131; 5,892,857; 5,901,259; 5,903,330; 5,908,916; 5,930,017; 5,930,412; 5,935,491; 5,937,115; 5,937,341; 5,940,417; 5,943,154; 5,943,464; 5,948,322; 5,948,915; 5,949,943; 5,953,469; 5,959,159; 5,959,756; 5,962,658; 5,963,683; 5,966,233; 5,970,185; 5,970,186; 5,982,958; 5,982,961; 5,985,084; 5,987,202; 5,993,700; 6,001,958; 6,005,058; 6,005,707; 6,013,748; 6,017,470; 6,020,457; 6,022,671; 6,025,453; 6,026,205; 6,033,773; 6,033,774; 6,037,105; 6,041,157; 6,045,888; 6,047,095; 6,048,928; 6,051,722; 6,061,481; 6,061,487; 6,067,186; 6,072,920; 6,081,632; 6,081,634; 6,081,794; 6,086,794; 6,090,322; and 6,091,879.

The foregoing references provide instruction and guidance to fabricate waveguides from materials generally of the types described herein using approaches such as direct photolithography, reactive ion etching, excimer laser ablation, molding, conventional mask photolithography, ablative laser writing, or embossing (e.g., soft embossing). The foregoing references also disclose polarizable chromophore compounds that may be incorporated into the polymers useful in the method of the invention.

Components of optical communication systems that may be fabricated, in whole or part, with materials according to the present invention include, without limitation, straight waveguides, bends, single-mode splitters, couplers (including directional couplers, MMI couplers, star couplers), routers, filters (including wavelength filters), switches, modulators (optical and electro-optical, e.g., birefringent modulator, the Mach-Zender interferometer, and directional and evanescent coupler), arrays (including long, high-density waveguide arrays), optical interconnects, optochips, single-mode DWDM components, and gratings. The materials described herein may be used with, for example, wafer-level processing, as applied in, for example, vertical cavity surface emitting laser (VCSEL) and CMOS technologies.

In many applications, the materials described herein may be used in lieu of lithium niobate, gallium arsenide, and other inorganic materials that currently find use as light-transmissive materials in optical communication systems.

The materials described herein may be used in telecommunication, data communication, signal processing, information processing, and radar system devices and thus may be used in communication methods relying, at least in part, on the optical transmission of information. Thus, a method according to the present invention may include communicating by transmitting information with light, where the light is transmitted at least in part through a material including a polymer of the invention or related macrostructure.

The materials of the present invention can be incorporated into various electro-optical devices. Accordingly, in another aspect, the invention provides electro-optic devices including the following:

an electro-optical device comprising a polymer or related macrostructure according to the present invention;

a waveguide comprising a polymer or related macrostructure according to the present invention;

an optical switch comprising a polymer or related macrostructure according to the present invention;

an optical modulator comprising a polymer or related macrostructure according to the present invention;

an optical coupler comprising a polymer or related macrostructure according to the present invention;

an optical router comprising a polymer or related macrostructure according to the present invention;

a communications system comprising a polymer or related macrostructure according to the present invention;

a method of data transmission comprising transmitting light through or via a polymer or related macrostructure according to the present invention;

a method of telecommunication comprising transmitting light through or via a polymer or related macrostructure according to the present invention;

a method of transmitting light comprising directing light through or via a polymer or related macrostructure according to the present invention;

a method of routing light through an optical system comprising transmitting light through or via a polymer or related macrostructure according to the present invention;

an interferometric optical modulator or switch, comprising: (1) an input waveguide; (2) an output waveguide; (3) a first leg having a first end and a second end, the first leg being coupled to the input waveguide at the first end and to the output waveguide at the second end; and 4) and a second leg having a first end and a second end, the second leg being coupled to the input waveguide at the first end and to the output waveguide at the second end, wherein at least one of the first and second legs includes a polymer or related macrostructure according to the present invention;

an optical modulator or switch, comprising: (1) an input; (2) an output; (3) a first waveguide extending between the input and output; and (4) a second waveguide aligned to the first waveguide and positioned for evanescent coupling to the first waveguide; wherein at least one of the first and second legs includes a polymer or related macrostructure according to the present invention, the modulator or switch may further including an electrode positioned to produce an electric field across the first or second waveguide; and

an optical router comprising a plurality of switches, wherein each switch includes: (1) an input; (2) an output; (3) a first waveguide extending between the input and output; and (4) a second waveguide aligned to the first waveguide and positioned for evanescent coupling to the first waveguide; wherein at least one of the first and second legs includes a polymer or related macrostructure according to the present invention, the plurality of switches may optionally be arranged in an array of rows and columns.

The method of the invention provides for low temperature imprinting that is solvent-less and provides direct patterning of organic functional materials. The method includes a thermally crosslinkable polymer system that can act as a host to small-molecule organic functional materials. Alternatively, the thermally crosslinkable polymer system can include a crosslinkable polymer to which has been covalently coupled an organic functional material. Crosslinkable polymers having pendant polarizable chromophore groups that may be formed into films and imprinted by the method of the invention are described in WO 04/065615, incorporated herein by reference in its entirety. In either case, the Diels-Alder [4+2] cyclo-addition reaction provides a thermally controlled crosslinking element at a relatively low temperature (˜80° C.). The Diels-Alder reactive groups are attached to a polystyrene chain that can be copolymerized with other polymers. The polystyrene Diels-Alder (PSDA) polymer useful in the method of the invention also benefits from a furan-capped malemide group that inhibits polymer crosslinking until the furan group is released by heating to ˜100° C. As a result of the polymer's composition, the polymer is very soft when initially cast as a thin film (T_{g}˜80° C.), but when heated enough to release the protecting furan group, the Diels-Alder crosslinkers are “activated.” Once activated, a temperature dwell at ˜80° C. will facilitate the DA crosslinking, and when cooled to room temperature the film is fully cured with a T_{g}˜130° C. and resistance to common solvents.

By incorporating PSDA material into an imprinting process, great benefits are realized. Essentially acting as two materials, first soft then hard, the crosslinkable polymers useful in the method (e.g., PSDA) can be imprinted in the initial “soft” state at a low temperature and then cooled to the “hard”, crosslinked state. The final result is a robust, highly customizable, polymer system that can be imprinted with nanoscale fidelity at a temperature suitable for organic functional materials.

The following examples are provided for the purpose of illustrating, not limiting, the invention.

### EXAMPLES

### Example 1

### A Representative Imprinted Polymer Film Fabrication Method

In this example, the fabrication of a representative imprinted polymer film is described. The method is useful in the fabrication of active and passive optical circuitry. In the method, a silicon “stamp” with etched features (e.g., such as to provide waveguides) is pressed into a heated polymer film, transferring the stamp pattern to the polymer. The two are then separated and the stamp is almost indefinitely reusable. In the method, a compression/lamination press capable of programmable heating and pressure applied between to very level platens is used. This press is fully clean room compatible, an added benefit making for easy integration of the method into manufacturing processes. A schematic illustration of the method is illustrated in FIG. 2.

All imprinting was done using a Tetrahedron MTP-13 laminating press (Tetrahedron Associates, San Diego, Calif.). Silicon stamps were prepared using photolithography or e-beam lithography (photonic crystal designs) and then etched using reactive ion etching (RIE). Easy separation of stamp and substrate was facilitated by applying a fluorinated self-assembled monolayer to the stamp surface. The polymer film to be imprinted was spin cast onto either 100 mm silicon wafers or 1 cm² diced silicon chips. The size of stamp and substrate were always comparable.

The polymers imprinted include polymethylmethacrylate (PMMA, 75K), an amorphous polycarbonate (APC), and a polystyrene (PS). These were all solvated in cyclopentanone to 15% by weight. Additional imprinting was done on guest/host polymer films incorporating FTC-type EO chromophores into the above polymers. These were prepared with the EO chromophore doped at 15% by weight into the polymer host. This mixture was then dissolved 15% total solid weight in cyclopentanone. All polymer films were spun to produce a layer (thickness about 1 micron) for imprinting.

The imprinting process flow was as follows: The stamp and substrate were placed together in the press; the press was heated to the desired temperature; pressure was applied to 100 psi for 10 minutes; the platens were cooled to room temperature; pressure was released and the stamp and substrate separated with little difficulty. Total run time including heating and cooling was 45 minutes. Imprinted films were analyzed by optical microscopy and SEM. Fabricated devices were characterized by normal optical test procedures.

### Example 2

### The Preparation and Characterization of a Representative Crosslinkable Polymer

In this example, the preparation and characterization of a representative crosslinkable polymer, PSDA, useful for nanoimprint lithography methods is described.

General method. All chemical reagents were purchased from Aldrich and were used as received unless otherwise specified. All reactions were carried out under inert nitrogen atmosphere unless otherwise specified. ¹H NMR spectra (200 MHz) were taken on a Bruker-200 FT NMR spectrometer, all spectra were obtained in CDCl₃ (unless otherwise noted) at 18° C.

The preparation of a PSDA, a representative thermally crosslinkable polymer is described below and illustrated in FIG. 3.

Furan adduct of N-carboxyethylmaleimide (1). To a solution of maleic anhydride (33.6 g, 377 mmol) and D-alanine (36.96 g, 377 mmol) in 400 mL of acetic acid was added 52 mL of toluene, the mixture became opaque suspension until heated to 140° C. The resulting clear solution was refluxed for 5 hours followed by addition of 50 mL of toluene was added. Azeotropic distillation using a Dean-Stark apparatus separated 31 mL of acetic acid/water mixture in the next 4 hours. The reaction mixture was cooled to 90° C. and solvent was removed via distillation with a water aspirator. The residue viscous oil was taken up in 200 mL of acetone and concentrated. The crude product was purified by flash chromatography on silica gel with a gradient eluent of 5-12% methanol in dichloromethane to afford 35 g of N-carboxyethylmaleimide as white solid. ¹H NMR (CDCl₃): 6.70 (s, 2H), 3.81 (t, 7.2 Hz, 2H), 2.68 (t, 7.2 Hz, 2H), 2.14 (s, 1H).

To N-carboxyethylmaleimide (1.01 g, 6 mmol) and furan (4.08 g, 60 mmol) in a 100 mL flask was added 19 mL of benzene at room temperature. The resulting mixture was heated to 75° C. and reflux for 12 hours. The mixture was cooled to room temperature and concentrated via rotary evaporator to afford the resulting white solid 1.4 g (99%), which was used without further purification. ¹H NMR (CDCl₃): 6.49 (s, 2H), 5.07 (s, 2H), 3.50 (t, 7.2 Hz, 2H), 2.87 (s, 2H), 2.37 (t, 7.4 Hz, 2H).

PSDA. To a solution of poly(4-vinylphenol-co-methyl methacrylate) (51 mol. % 4-vinylphenol) (0.5 g, 2.31 mmol 4-vinylphenol, Mw about 2,000), 4-(dimethylamino)pyridinium 4-toluenesulfonate (DPTS) (30 mg, 0.102 mmol) and furan adduct of N-carboxyethylmaleimide (121 mg, 0.508 mmol), prepared as described above, in 15 mL of THF was slowly added 4 mL of dichloromethane. The resulting solution was stirred for 15 minutes. Dicyclohexylcarbodiimide (DCC) (126 mg, 0.61 mmol) was added in one portion and the resulting mixture was stirred at room temperature for 12 hours. Likewise, DPTS (30 mg, 0.102 mmol) and 3-(2-furyl)propanoic acid (71.2 mg, 0.508 mmol) were added into reaction mixture and stirred for 15 minutes before DCC (126 mg, 0.61 mmol) was added in one portion. The resulting mixture was stirred for another 12 hours. Finally, DPTS (102 mg, 0.347 mmol), pentafluorobenzoic acid (367 mg, 1.73 mmol) and additional 5 mL of THF were added into reaction mixture and stirred for 15 minutes before DCC (429 mg, 2.079 mmol) was added in one portion. The resulting mixture was stirred for 12 hours and filtered through a 0.2 mm disc. Solvent was removed via rotary evaporator and the remaining viscous oil was dissolved in 5 mL of THF. The white solid was filtered through 0.2 mm disc again. This process was repeated in THF for three times and dichloromethane once. The residue was then dissolved in 5 mL of THF and concentrated to 2 mL of saturated solution, which was then precipitated in 200 mL of methanol. The polymer solid was collected by filtration, redisolved in 5 mL of THF, and the purification was repeated four times to obtain 500 mg of polymer PSDA as white solid (80%).

Molecular weight of polymer product by Gel Permeation Chromatography (GPC): Mw=5,500. Glass transition temperature by Differential Scanning Calorimeter (DSC): Tg about 80° C.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for making a crosslinked polymer film, comprising subjecting a crosslinkable polymer film comprising a thermoreversibly crosslinkable polymer to a temperature and for a time sufficient to provide a crosslinked polymer film comprising a thermoreversibly crosslinked polymer.

2. The method of claim 1, wherein the crosslinkable polymer comprises one or more diene moieties and one or more dienophile moieties, the diene and dienophile moieties being reactive to form 4+2 cycloaddition moieties.

3. The method of claim 1, wherein the crosslinked polymer comprises one or more 4+2 cycloaddition moieties, the 4+2 cycloaddition moieties being reactive to form diene and dienophile moieties.

4. The method of claim 2, wherein the dienophile moieties comprise maleimide moieties.

5. The method of claim 2, wherein the diene moieties comprise furan moieties.

6. The method of claim 1, wherein the crosslinkable polymer film further comprises an organic functional material.

7. The method of claim 1, wherein the crosslinked polymer film further comprises an organic functional material.

8. The method of claim 6, wherein the organic functional material comprises a nonlinear optical chromophore.

9. A polymer film made by the method of claim 1.

10. A lattice, comprising a thermoreversibly crosslinked polymer.

11. An electro-optic device, comprising a thermoreversibly crosslinked polymer.

12. A method for imprinting a pattern on a polymer film, comprising:
(a) contacting a crosslinkable polymer film supported on a substrate with stamp having a pattern, wherein the crosslinkable polymer film comprises a thermoreversibly crosslinkable polymer;
(b) subjecting the crosslinkable polymer film to a temperature and pressure and for a time sufficient to imprint the film with the pattern to provide an imprinted polymer film, wherein the crosslinkable polymer film remains crosslinkable at the temperature and pressure sufficient to imprint the pattern; and
(c) cooling the imprinted polymer film to a temperature and for a time sufficient to provide an imprinted, crosslinked polymer film.

13. The method of claim 12, wherein the crosslinkable polymer film further comprises an organic functional material.

14. The method of claim 12, wherein the crosslinked polymer film further comprises an organic functional material.

15. A method for making a crosslinked polymer having electro-optic activity, comprising:
(a) heating a polymer film to form a softened polymer film, the softened polymer film comprising
(i) one or more polarizable chromophore compounds, and
(ii) a crosslinkable polymer comprising one or more diene moieties and one or more dienophile moieties, wherein the diene and dienophile moieties are reactive to form 4+2 cycloaddition moieties;
(b) subjecting the softened polymer film to an electric field to provide a poled polymer film comprising aligned, polarizable chromophore compounds; and
(c) cooling the poled polymer film to a temperature and for a time sufficient to provide a hardened, crosslinked polymer film having electro-optic activity, wherein the crosslinked polymer film comprises a crosslinked polymer having one or more 4+2 cycloaddition moieties.

16. The method of claim 15, wherein cooling the poled polymer film to provide a hardened, crosslinked polymer film comprises reacting one or more diene moieties with one or more dienophile moieties to form one or more 4+2 cycloaddition moieties.

17. The method of claim 15 further comprising:
(a) heating the hardened, crosslinked polymer at a temperature sufficient to provide a softened, crosslinkable polymer;
(b) subjecting the softened, crosslinkable polymer to an electric field to provide a poled polymer film; and
(c) cooling the poled polymer film to a temperature sufficient to provide a hardened, crosslinked polymer having electro-optic activity.

18. The method of claim 17, wherein heating the hardened, crosslinked polymer to provide a softened, crosslinkable polymer comprises heating the crosslinked polymer at a temperature sufficient to cause one or more 4+2 cycloaddition moieties to react to form one or more diene moieties and one or more dienophile moieties.

19. A film, comprising a crosslinkable polymer comprising:
(a) one or more diene moieties; and
(b) one or more dienophile or dienophile precursor moieties; wherein the diene and dienophile moieties are reactive to form 4+2 cycloaddition moieties.

20. The film of claim 19, wherein the dienophile moieties comprise maleimide moieties.

21. The film of claim 19, wherein the diene moieties comprise furan moieties.

22. The film of claim 19 further comprising an organic functional material.

23. The film of claim 22, wherein the organic functional material is a nonlinear optical chromophore.

24. An imprinted film, comprising a crosslinked polymer comprising one or more 4+2 cycloaddition moieties, wherein the 4+2 cycloaddition moieties are reactive to form diene and dienophile moieties.

25. The film of claim 24, wherein the dienophile moieties comprise maleimide moieties.

26. The film of claim 24, wherein the diene moieties comprise furan moieties.

27. The film of claim 24 further comprising an organic functional material.

28. The film of claim 27, wherein the organic functional material is a nonlinear optical chromophore.
